(19) United States
(12) Patent Application Publication
(10) Pub. No.: US 2005/0230963 A1
(43) Pub. Date: Oct. 20, 2005

(54) Sticker book with stickers employed on the book's cover

(76) Inventors: John C. McDowell, Duluth, GA (US); Jeffrey D. Mullen, Scarsdale, NY (US)

Correspondence Address: FISH & NEAVE IP GROUP;ROPES & GRAY LLP, 1251 AVENUE OF THE AMERICAS FL C3, NEW YORK, NY, 10020-1105, US

(21) Appl. No.: 10/978,210

(22) Filed: Oct. 28, 2004

Related U.S. Application Data
(60) Provisional application No. 60/515,329, filed on Oct. 30, 2003.

(51) Int. Cl. B42D 15/00

(52) U.S. Cl. 283/81

(57) ABSTRACT

The present invention reduces the cost of producing a sticker book by incorporating stickers on the book's cover. As a result, the need for sticker pages is eliminated. In turn, the cost of manufacturing a sticker book is reduced.

### CROSS-REFERENCE TO RELATED APPLICATIONS

This applicant claims the benefit of Provisional U.S. patent application Ser. No. 60/515,329 filed on Oct. 28, 2003, which is hereby incorporated by reference herein in its entirety.

### BACKGROUND OF THE INVENTION

Traditional sticker books consist of a front cover, pages with die-cut stickers, pages adapted to receive die-cut stickers, and a rear cover. One example of such a traditional sticker book is discussed in U.S. Pat. No. 5,269,691.

The sticker-containing pages of a traditional sticker book are located in the interior pages of the sticker book. Occasionally, traditional sticker pages are located in a sticker book as the pages closest to, or farthest away from, the book's cover. Furthermore, the pages of a traditional sticker book are occasionally fabricated as sheets that are folded such that each side of the fold is a separate page of the book (or pair of page surfaces).

Books are occasionally manufactured as picture books. The standard picture book has a length of 32 pages and is fabricated from page sheets cut from manufacturing sheets. The page sheets are folded and bound together by a book cover in order to form the picture book.

A traditional sticker book, however, is substantially more expensive to manufacture than a picture book. The increased cost is a result of the need to make three separate types of components—sticker sheets, book covers, and page sheets. The manufacturing process has to be able to organize and utilize all three components. As a result, the manufacturing process for a sticker book is more complex, and therefore more expensive, than the manufacturing process for a two component picture book. Additionally, sticker sheets and book covers are occasionally the high cost items for a sticker book. It is therefore desirable to provide sticker books that are inexpensive, and relatively simple, to manufacture.

Furthermore, traditional sticker sheets do not provide a utility to the user after the stickers are removed from the sticker sheets. Without stickers, traditional sticker pages are blank and unappealing. It is therefore desirable to increase the whimsical and festive nature of sticker books.

### SUMMARY OF THE INVENTION

One object of the present invention is to provide a two component sticker book. As a result, traditional two component picture book manufacturing processes may be utilized to fabricate a sticker book without any substantial modifications. Put another way, the present invention provides a simplified and compact process for fabricating sticker books.

In particular, a sticker book is provided with a book cover that houses removable stickers such as die-cut stickers. In this manner, at least four page surfaces may be utilized to house die-cut stickers (more surfaces are available if, for example, the exterior surface of the spine is utilized). As a result of including removable stickers on a sticker book's cover, interior sticker sheets are not needed to realize the functionality of a sticker book. Such a two component sticker book may therefore cost considerably less to manufacture that a traditional sticker book.

As a result of a sticker functionality without a sticker sheet, one or more additional non-sticker pages may be included in the sticker book. Sticker sheets are occasionally thicker than, for example, single-layer paper sheets. Thus, removing one sticker sheet may allow for multiple single-layer paper sheets to be included in the location of the removed sticker sheet. Looking at the cost advantage of a two component sticker book from a different perspective, the cost of replacing a book cover with a sticker-based book cover may be less than the cost of replacing a non-sticker sheet with a sticker sheet. The cost savings may then be utilized as profit, to increase the number of books that are manufactured, or reinvested back into the book (e.g., by adding additional non-sticker sheets). Even if the cost savings per book is only a nickel, the savings may be a considerable portion of the manufacturing costs (e.g., 5%). For example, a savings of $0.05 for a sticker book that costs $1.00 per unit may translate to a savings of $2,500 if, for example, 50,000 books are manufactured

Furthermore, by including stickers on the exterior cover of the sticker book, a user is visually presented with the stickers of the sticker book. As a result, a user does not have to open the sticker book in order to enjoy the whimsical and festive nature of the sticker book. Moreover, a user does not have to open the sticker book in order to remove stickers from the sticker book—allowing the user to more easily remove stickers and place these stickers on nearby objects (e.g., the user's skateboard).

Indicia may be provided underneath each sticker such that, after a sticker is removed from the book's cover, the book cover retains at least a portion of its whimsical and festive nature. The indicia located underneath the sticker may be identical to the indicia located on the sticker. Alternatively, the indicia located beneath the sticker may be different than the indicia located on the sticker. Both the indicia located beneath the sticker and the indicia located on the sticker may have a similar theme (e.g., the sticker-indicia may be a sleeping animal while the underlying indicia is an animal “on the prowl”).

### BRIEF DESCRIPTION OF THE DRAWINGS

The above and other objects and advantages of the present invention will be apparent upon consideration of the following detailed description, taken in conjunction with accompanying drawings, in which like reference characters refer to like parts throughout, and in which:

FIG. 1 is an illustration of the exterior of a sticker book cover constructed in accordance with the principles of the present invention;

FIG. 2 is an illustration of the interior of a sticker book constructed in accordance with the principles of the present invention;

FIG. 3 is an illustration of a sheet of sticker book covers on a manufacturing sheet constructed in accordance with the principles of the present invention;

FIG. 4 is an illustration of a sticker book cover constructed in accordance with the principles of the present invention; and

FIG. 5 is an illustration of a sticker book constructed in accordance with the principles of the present invention.

### DETAILED DESCRIPTION

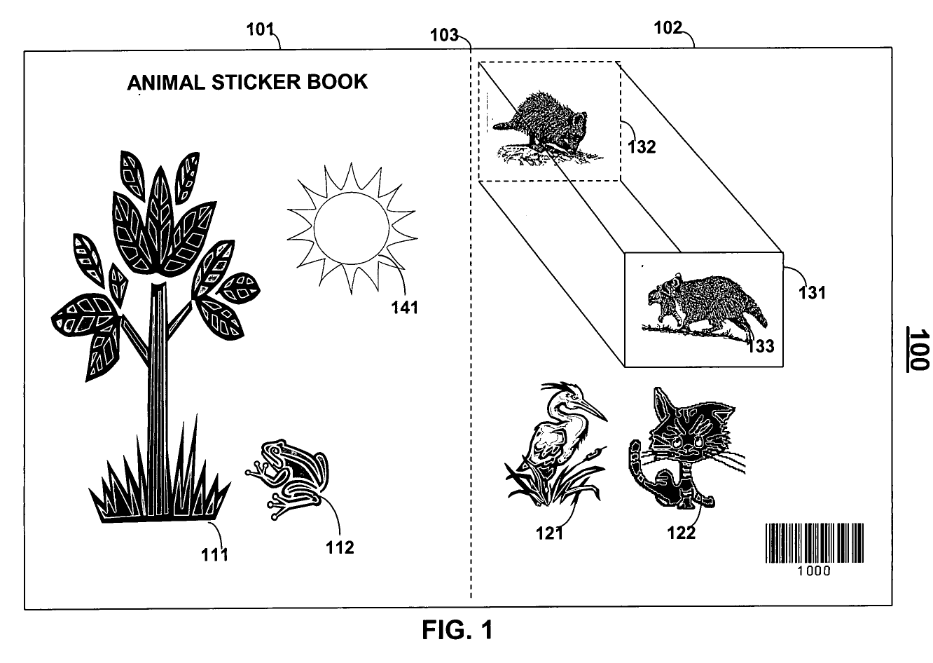

FIG. 1 shows the exterior of sticker book cover 100. Sticker book cover 100 includes front cover 101 and rear cover 102 defined by fold line/portion 103. Sticker book cover 100 may include removable stickers 111, 112, and 141. Stickers 111, 112, 141 may be, for example, die cut stickers.

Stickers 111, 112, and 141 may include indicia that are part of an overall illustrative scene on sticker book cover 100 (or a portion of sticker book cover 100). For example, front cover 101 may include indicia associated with the theme of a life-infested forest. In this manner, stickers 111, 112, and 141 may include indicia of forest life that adds to a life-infested forest illustration and/or the theme of a life-infested forest. Alternatively, front cover 101 may not include any indicia, but stickers 111, 112, and 141 may include indicia that exclusively create an overall illustrative scene.

Alternatively, the stickers may not form any overall illustrative scene. For example, stickers 121, 122, and 131, as shown, are organized in a tabular format (e.g., organized in columns and rows). As shown by sticker 131, the stickers of the present invention may be cut in shapes other than their respective indicia. Sticker 131, for example, is a rectangular sticker that includes indicia 133. Indicia may also be provided beneath the stickers of the present invention. For example, indicia 132 may be included on a portion of book cover 102 beneath sticker 131. Additionally, indicia 132 may share common attributes with indicia 133 (e.g., both may show the same animal, but the two animals may be in different poses).

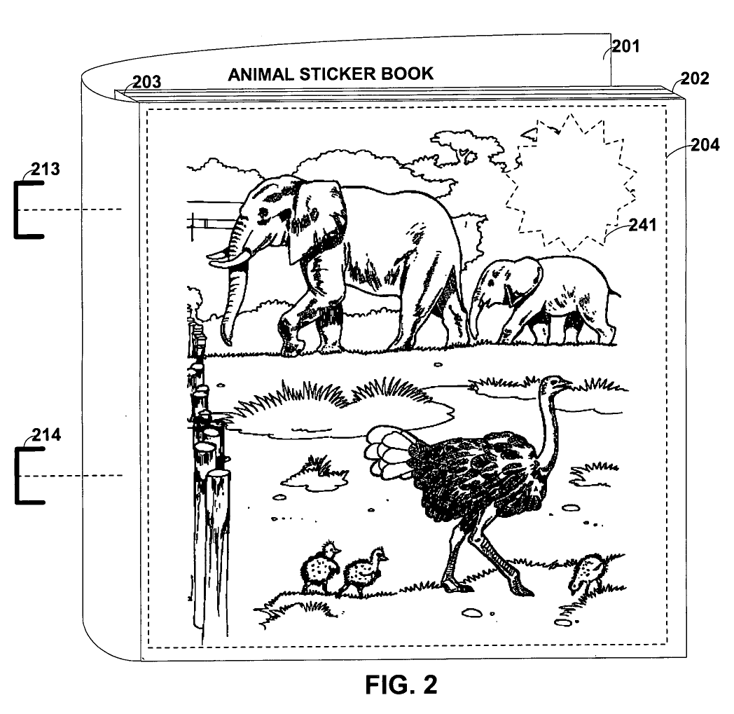

FIG. 2 illustrates sticker book 200 that includes cover 201 that is operable to house stickers such as, for example, die cut stickers. Sticker book cover 201 is fixed to non-sticker pages 202 by staples 213 and 204. Other fixing means, however, may be employed. For example, sticker book cover 201 may be glued or velo-binded to pages 202. Stickers may also be included on the spine (portion 203) of sticker book cover 201.

Indicia 204 may be included on non-sticker book pages 202. Indicia 204 may have the same theme, for example, as the stickers housed on sticker book cover 201 (e.g., marine life or African wild-life). Indicia 204, like any sticker of the present invention, may be in color. Alternatively, Indicia 204 may be black and white. Outlines may be included on indicia 204 (or may be embodied as indicia 204). Such outlines may have shapes that correspond to the shapes of the die-cut stickers (not shown) of sticker book 200. For example, outline 241 may be provided that corresponds to sticker 141 of FIG. 1. In this manner, outlines may provide the functionality of markers for possible, or visually preferable, sticker locations. Such a functionality would be beneficial to young users and would also provide the functionality of a game as young children tried to match sticker shapes to outline shapes.

Pages 202 and/or indicia 204 may be operable to receive marks created by markers, crayons, or other customizable devices. For example, pages 202 may be fabricated from a paper that is able to receive marks from crayons, pencils, and/or pens. Such pages 202 may be operable to permanently receive stickers such that the stickers may not be removed once the stickers are placed on pages 202. For example, the stickers may include an adhesive (e.g., a glue) that permanently attaches to paper (i.e., removing a sticker would most likely tear the sticker or the paper). Alternatively, pages 202 may be operable to temporarily receive stickers such that the stickers may be removed from, and reattached to, pages 202. For example, the stickers may be static-cling stickers and pages 202 may be operable to receive static-cling stickers. For the purposes herein, a static-cling exists between a medium and a sticker when that sticker can firmly attach to the medium without an adhesive. Accordingly, the stickers, pages, and book covers of the present invention may be fabricated from a polymer or have, for example, a polymer-based coat.

Persons skilled in the art will appreciate that sticker pages may also be included in sticker book 201. For example, sticker book pages may be included between pages 202 and book cover 201. As per another example, one or more of pages 202 may be sticker pages housing additional stickers.

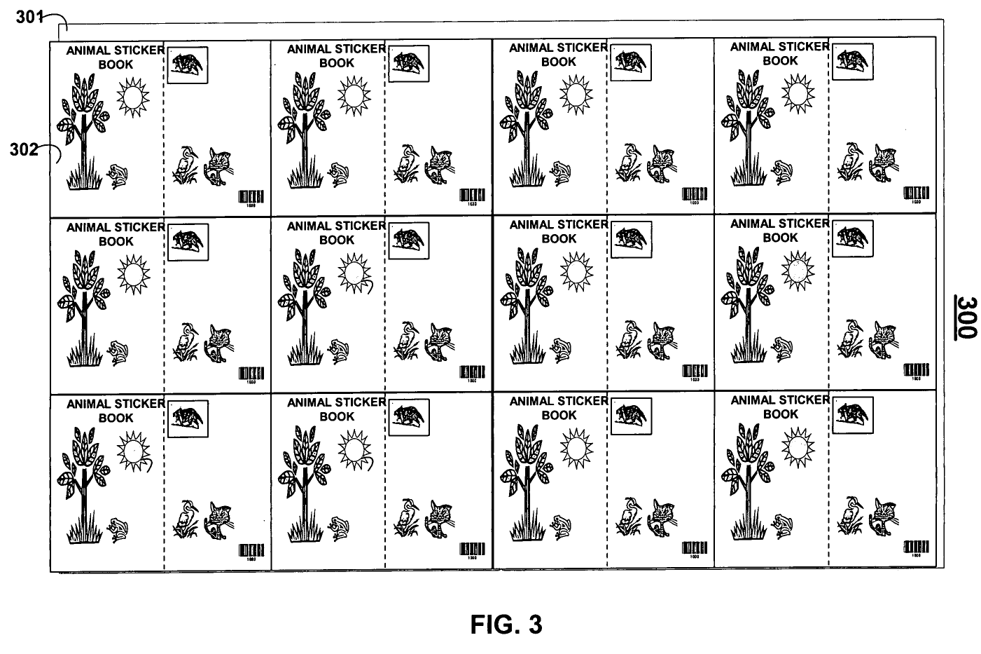

FIG. 3 shows manufacturing book cover sheet 300 that includes sheets 302 and 301. Sheet 302 may be, for example, a polymer sheet that includes indicia—such as indicia intended to become one or more stickers (or a portion of sticker). Sheet 301 may be, for example, a backing sheet such as a piece of paper or cardboard. Sheet 301 may be attached to sheet 302 by means of, for example, an adhesive. For example, an adhesive (e.g., a glue) may be placed on a portion of sheet 301 (e.g., the perimeter of sheet 301) and sheet 302 may accordingly be fixed to sheet 301. Alternatively, the adhesive may be placed on sheet 302. Such adhesives may have a weak bond such that the stickers of sheet 302 may be removed (if the adhesive is placed beneath the stickers of sheet 302). Alternatively, sheets 302 and 301 may be pressed together. The adhesive may, however, allow the die-cut stickers to adhere to another surface (e.g., the surface of the pages of the sticker book). Alternatively, the stickers may adhere to the sticker book pages through a static, or other type of natural, bond. The perimeter of each of the individual sticker book covers of sheet 302 may also be permanently adhered to sheet 301 (e.g., around the perimeter of the individual sticker book covers). This may be done, for example, with a permanent glue. A secondary adhesive may be utilized to provide the sticker-functionality.

As the manufacturing process continues, the combined sheets 301 and 302 are preferably cut into individually sticker book covers and attached to sticker book pages. A second sticker sheet may also be attached to the reverse side of sheet 301 such that both sides of sheet 301 houses stickers. Furthermore, the stickers of sheet 300 may be cut, for example, through a mechanical process that cuts through sheet 302, but not sheet 301. Sheets 301 and 302 may also be kept together by mechanically crushing the sheets together. Generally, a adhesive may be provided on the back of sheet 302, and sheet 302 may be attached to sheet 301, such that when portions of sheet 302 (e.g., stickers) are removed from sheet 301, these portions may be attached, or fixed, to other surfaces by means of the adhesive.

Backing sheets of different thickness and/or firmness, however, may be utilized depending upon whether the sticker sheet is being utilized as a interior sticker page or a sticker cover. For example, a thick cardboard may be utilized to fabricate a backing sheet while one or more layers of paper may be utilized to fabricate a interior sticker book page.

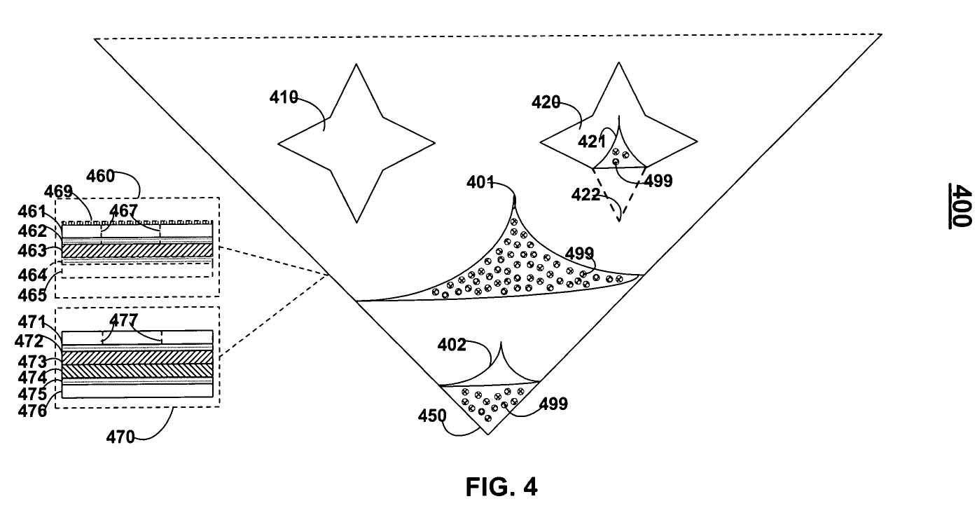

FIG. 4 shows a portion of sticker book cover 400. Stickers 410 and 420 may be included as a part of sticker sheet 401. For example, sticker 420 may be removable from die-cut area 422 (as shown by removed portion 421). Adhesive 499 may be included on a surface of sheet 401 and/or stickers 410 and 420. Such an adhesive may be operable, for example, to allow stickers 410 and 420 to fix to a nearby surface after stickers 410 and 420 are removed from sheet 402. Sheet 401 may be similar to, for example, sheet 303 of FIG. 3. Sheet 402 may be similar to, for example, sheet 301 of FIG. 3.

Sheet 450 may also be provided, for example, such that book cover 400 may house stickers on both sides. Sheet 450 may include adhesive 499 and may be attached to, for example, sheet 402 similar to the way sheet 401 is attached to sheet 402.

Sheet 400 of FIG. 4 may take the form of, for example, configuration 460. Configuration 460 includes sheet 461 attached to backing sheet 463. Adhesive 462 is provided between sheet 461 and backing sheet 463. Adhesive 462 may be provided, for example, such that a stronger bond exists between adhesive 462 and sheet 461 than the bond between adhesive 462 and sheet 463. For example, adhesive 462 may be a double-sided tape with a different type of adhesive on each side (e.g., glues with different bonding strengths).

Persons skilled in the art will appreciate that the strength of the bond between an adhesive and a sheet may be changed by changing the properties of the sheet instead of changing the properties of the adhesive (e.g., the attributes of the surface of a sheet). For example, the strength of a bond between a tape and a smooth surface may be different than the bond between that same tape and a rough surface. Alternatively, the strength of a bond between a tape and a plastic may be different than the bond between a tape and a paper. In this manner, sheet 461 may be, for example, a sheet of paper with a gloss finish on the side of sheet 461 opposite adhesive 462. Sheet 463 may then be, for example, a sheet of paper with a gloss finish (e.g., a smooth friction-reduced finish) on the side of sheet 463 adjacent to adhesive 462. As a result, adhesive 462 may have a stronger bond with sheet 461 than sheet 463 such that when a sticker (e.g., the sticker defined by cuts 467) is removed from sheet 461, adhesive 462 remains bonded to the portion of sheet 461 defining the sticker—but separates from sheet 463.

A transparent protection sheet (e.g., layer 469) may be provided, for example, above a surface of a book cover that defines a removable sticker. If, for example, the exterior of a book cover defines a removable sticker then, for example, a transparent sheet may be provided over the exterior of the book cover (or a portion of the exterior of the book cover) such that the transparent sheet has to be removed to remove the sticker. As a result, users viewing the sticker book at a book store may be deterred from removing a sticker. The users, however, would still be able to view the sticker. Alternatively, the overlying sheet may be non-transparent (or have non-transparent portions) such that the user does not know what stickers are defined in the exterior of the book cover. Thus, an element of curiosity, wondering, and ultimately surprise is introduced.

A sticker may then be formed, for example, by cutting lines 467 into sheet 461. Adhesive 461 may alternatively be selectively provided between sheet 461 and sheet 463. For example, adhesive 461 may only be provided beneath the area between cuts 467. Persons skilled in the art will appreciate that cuts 467 may extend into adhesive 462 and extend to (e.g., abut) layer 463. If a book cover with stickers on both the interior and exterior surface is desired, stickers may be provided, for example, on the side of sheet 463 opposite sheet 461. For example, sheet 461 and adhesive 464 may be provided.

Sheet 400 of FIG. 4 may alternatively take the form of, for example, configuration 470. Configuration 470 includes two sheets 473 and 474. Sheets 473 and 474 may be fixed together with an adhesive such as, for example, a glue. The advantages of configuration 470 are numerous. Configuration 470, for example, may be manufactured by a process that manufactures a single-sided sticker sheet. To fabricate configuration 470, two such single-sided sheets may be fabricated and fixed together. Configuration 470 additional may be less-flexible than, for example, configuration 460. As a result, configuration 470 may provide additional benefit as a book cover. Configuration 470 includes sheet 471 disposed above adhesive 472. Adhesive 472 is disposed above sheet 473. Sheet 473 is attached to sheet 474 (e.g., via a permanent glue). Adhesive 475 is disposed between sheets 474 and 476.

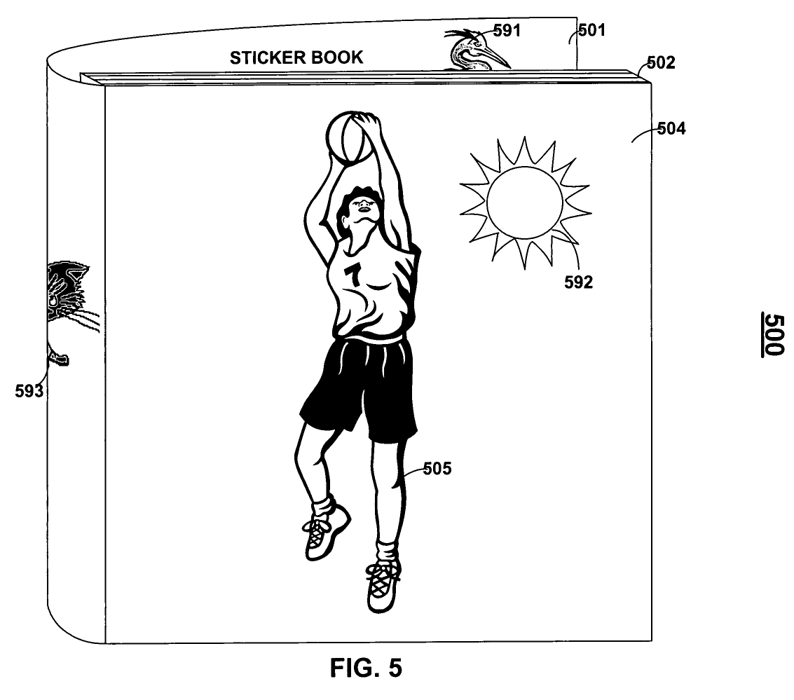

FIG. 5 shows sticker book 500 that includes pages 502 and 504 bound to the interior surface of sticker book cover 501. Removable stickers may be provided on any surface of sticker book 500. For example, sticker 591 may be provided on the exterior surface of book cover 501. As a result, a user may remove sticker 591 and apply sticker 591 to a different surface (or a different portion of the exterior of front cover 501). Sticker 592 may be provided on page 504 such that a user may remove sticker 592 and apply sticker 592 to a different surface (or a different portion of page 504. Sticker 593 may be provided on the interior surface of book cover 501. As a result, a user may remove sticker 591 and apply sticker 591 to a different surface (or a different portion of the interior of book cover 501).

Book cover 501 may be provided as sheet that is folded over one or more fold lines. Alternatively, book cover 501 may be provided as two or more separate covers (e.g., pages or sheets) that are fixed together to form book cover 501. Indicia may also be printed on any surface of book 500—including those surfaces that are not stickers. Indicia 505, for example, may be provided on a sticker sheet (or a non-sticker sheet) and may not be provided as a sticker. Indicia 505 may be a black and white outline such that a user may color indicia 505. In this manner, a coloring book functionality may be provided. Stickers may also be black and white and provided with a surface is adapted to receive a mark. In this manner, a sticker coloring functionality may be provided. Marking objects (e.g., crayons, markers, and/or pencils) may be packaged with (e.g., attached to) book 500. Book 500 may take on any illustrative form. For example, book 500 may be a story book or a game book.

Additionally, book 500 may be provided such that removable stickers are only provided on the exterior surface of book cover 501. Book 500 may alternatively be provided such that removable stickers are only provided on the interior surface of book cover 501.

From the foregoing description, persons skilled in the art will recognize that this invention provides a sticker book with stickers defined in the book's cover. In addition, persons skilled in the art will appreciate that the various configurations described herein may be combined without departing from the present invention. It will also be recognized that the invention may take many forms other than those disclosed in this specification. Accordingly, it is emphasized that the invention is not limited to the disclosed methods, systems and apparatuses, but is intended to include variations to and modifications thereof which are within the spirit of the following claims.

1. A sticker book comprising:
a book cover having an interior surface and housing at least one sticker, wherein said at least one sticker is removable from said book cover and is operable to attach to a different surface, said book cover comprising:
a first sheet comprising said at least one sticker, wherein an adhesive is located on a first surface of said at least one sticker.
a second sheet attached to said first sheet such that said adhesive is located between said at least one sticker and said second sheet; and
a plurality of non-sticker housing pages bound to said interior surface of said book cover.

2. The sticker book of claim 1, wherein said plurality of non-sticker housing pages is at least partially bound to said book cover by a staple.

3. The sticker book of claim 1, wherein said first surface is said interior surface.

4. The sticker book of claim 1, wherein said book cover has an exterior surface and said first surface is said exterior surface.

5. The sticker book of claim 1, wherein said book cover further comprises:
a third sheet having at least one additional sticker, wherein an additional adhesive is placed on a second surface of said at least one additional sticker, said third sheet is coupled to said second sheet such that said additional adhesive is located between said at least one additional sticker and said second sheet.

6. The sticker book of claim 1, further comprising indicia located on said at least one sticker.

7. The sticker book of claim 1, further comprising:
a theme;
first indicia located on said at least one sticker; and
second indicia located on said book cover, wherein said first indicia and said second indicia are associated with said theme.

8. The sticker book of claim 1, further comprising first indicia located on said second sheet.

9. The sticker book of claim 8, wherein said first indicia is aligned with said first sheet such that said first indicia is only provided beneath said at least one stickers when said first sheet and said second sheet are attached together.

10. The sticker book of claim 8, further comprising second indicia located on said first sheet.

11. The sticker book of claim 1, further comprising indicia located on said plurality of non-sticker pages.

12. The sticker book of claim 1, further comprising at least one sticker page bound to said interior surface of said at least one book cover.

13. The sticker book of claim 12, wherein said at least one sticker page is bound between said book cover and said plurality of non-sticker pages.

14. The sticker book of claim 1, wherein said at least one stickers are only provided on said interior surface of said book cover.

15. The sticker book of claim 1, wherein said book cover further comprises an exterior surface and said at least one stickers are only provided on said exterior surface of said book cover.

16. The sticker book of claim 1, further comprising at least one outline located on at least one of said plurality of non-sticker pages, wherein each one of said at least one outlines has a shape similar to one of said at least one stickers.

17. The sticker book of claim 1, wherein said book cover further comprises a third sheet coupled to said second sheet.

18. The sticker book of claim 17, wherein said book cover further comprises a fourth sheet, wherein said fourth sheet is coupled to said third sheet and a second adhesive is provided between said third sheet and said fourth sheet.

19. The sticker book of claim 18, wherein said fourth sheet comprises at least one additional stickers.

20. The sticker book of claim 19, further comprising at least one sticker sheets housing at least one stickers, wherein said at least one sticker sheets are bounded to said book cover.

21. A sticker book consisting essentially of:
a book cover having a theme, wherein said book cover comprises a plurality of removable stickers; and
a plurality of pages bound to said book cover.

22. The sticker book of claim 21, wherein said plurality of removable stickers are static-cling stickers.

23. The sticker book of claim 21, wherein said plurality of removable stickers include an adhesive such that said stickers are operable to permanently attach to a surface after said stickers are removed from said book cover.

24. The sticker book of claim 21, wherein said plurality of removable stickers include an adhesive such that said stickers are operable to temporarily attach to a surface after said stickers are removed from said book cover.

25. A sticker book consisting essentially of:
a book cover having a theme, wherein a plurality of removable stickers are defined in said book cover; and
a plurality of pages bound to said book cover.

26. A sticker book consisting of:
a book cover having a theme, wherein a plurality of removable stickers are defined in said book cover; and
a plurality of pages bound to said book cover.

27. A method for making a sticker book comprising:
fabricating a book cover, wherein a plurality of removable stickers are defined in said book cover;
fabricating a plurality of pages; and
binding said plurality of pages to said book cover.

28. The method of claim 27, further comprising:
fabricating a plurality of sticker sheets; and
binding said plurality of sticker sheets to said book cover.

29. The method of claim 27, further comprising:
printing indicia on said plurality of removable stickers.

30. The method of claim 27, further comprising:
printing indicia on an area of said book cover that does not define one of said plurality of stickers.

31. The method of claim 27, further comprising:
printing indicia on said plurality of pages.

32. The method of claim 27, further comprising:
providing a transparent protection sheet over the exterior surface of said book cover, wherein said plurality of stickers are defined in the exterior surface of said book cover.

33. The method of claim 27, wherein said fabricating said book cover comprises cutting said book cover from a book cover manufacturing sheet.
